(19) United States
(12) Patent Application Publication
(10) Pub. No.: US 2010/0149165 A1
(43) Pub. Date: Jun. 17, 2010

(54) PLASMA DISPLAY DEVICE AND SEMICONDUCTOR DEVICE

(76) Inventors: Takuo NAGASE, Hitachi (JP); Mutsuhiro Mori, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/609,258

(22) Filed: Oct. 30, 2009

(30) Foreign Application Priority Data
Oct. 30, 2008 (JP) 2008-279281

(51) Int. Cl. G09G 3/28; G09G 5/00

(52) U.S. Cl. 345/212; 345/60

(57) ABSTRACT

A plasma display device of the present invention having a plurality of display cells, comprises a X electrode kept at a reference voltage, a Y electrode, an address electrode, the X electrode and the Y electrode between which sustain discharge occurs, and an address driver comprising a first switch element Q2 for outputting a low level voltage, a second switch element Q1 for outputting a high level voltage, whose withstand voltage of the second switch element is lower than the first switch element, and a diode inserted and connected between the address electrode and the second switch element.

### CLAIM OF PRIORITY

The present application claims priority from Japanese patent application JP2008-279281 filed on Oct. 30, 2008, the content of which is incorporated by reference into this application.

### BACKGROUND OF THE INVENTION

1. Field of the Invention

The present invention relates to a plasma display device whose first electrode is kept at a constant voltage and a semiconductor device to be used for the plasma display device.

2. Description of the Related Art

An AC Plasma Display Device (referred to as “AC PDP Device” hereinafter) can be easily enlarged to have a larger display panel with its display panel remaining thin. Therefore more and more AC PDP Devices are sold in the market. However, because the large size AC PDP Device consumes a larger amount of electric power and is more costly than small ones, it is required to decrease electric power consumption as well as cost for the AC PDP Device.

FIG. 8 is a figure schematically indicating the cell structure in the display panel of an AC PDP Device. As is understood from FIG. 8, a display panel 102 has a front plate 1 and a rear plate 2 which are spaced apart from each other across a rib 3 interposed therebetween. A discharge gas such as xenon is included in a discharge space 4 that is formed between the front plate 1 and the rear plate 2. On the front plate 1 are formed Y electrodes 5y and X electrodes 5x which run in parallel with one another and are made of a transparent conductive film. A dielectric layer 6xy is formed on each of the Y electrodes 5y and on each of the X electrodes 5x. With this dielectric layer 6xy each of the Y electrode 5y and the X electrode 5x is insulated from the discharge space. On the other hand address electrodes 5a are formed on the rear plate 2. A dielectric layer 6a and a fluorescent material layer 7 are formed in this order from on the address electrode 5a. With this dielectric layer 6a every address electrode 5a is insulated from the discharge space 4.

As shown in FIG. 9, there are a plurality of X electrodes (X1, X2, - - - , Xm-1, Xm) and a plurality of Y electrodes (Y1, Y2, - - - , Ym-1, Ym) formed in the display panel 102 of the AC PDP Device with the X electrodes and the Y electrodes disposed alternately and all of the electrodes substantially in parallel with one another. There are also address electrodes (A1, A2, - - - , An, hereinafter referred to as “A electrode”) formed in the display panel 102, which run perpendicular to and intersect with the X electrodes and the Y electrodes. As a result, the X electrodes, the Y electrodes and the address electrodes constitute an electrode matrix in the display panel 102. A region along each A electrode between each X electrode and its adjacent Y electrode constitutes a display cell.

FIG. 10 shows wiring connections between a display panel of a generally available AC PDP Device and its principal driving circuits. This AC PDP Device comprises a display panel 102, a metal chassis 101 (housing), a scan-sustain driver circuit 103 for driving the Y electrodes in the display panel 102, a sustain driver circuit 104 for driving the X electrodes in the display panel 102, an address driver circuit 105 for driving the A electrodes and a driving control circuit 106 for receiving video signals and converting the input video signals into control signals to control the driver circuits 103, 104.

FIG. 11 shows a driving signal waveform for a common AC PDP Device. The driving signal waveform is divided in 3 consecutive periods. One is a reset period for homogeneously initializing all the display cells in a display panel 102. One is an address period for selecting display cells in each of which luminous discharge is caused to occur during a subsequent sustain period. The other is a sustain period for sustaining luminous discharge (discharge sustained period).

During the reset period is applied to the Y electrode the voltage gradually increasing from a voltage Vs/2 at a time t1 to a voltage of (Vs/2+Vset) at a time t2 according to a ramp function, while the voltage of the X electrode is kept set to a voltage −Vs/2. As a result, a weak discharge occurs both between the Y electrode and the X electrode and between the Y electrode and the A electrode and all the display cells are homogeneously initialized.

The address period is a time for selecting display cells in each of which luminous discharge is caused to occur during the subsequent sustain period. While keeping the X electrodes set to Vs/2, the driver circuits 103, 104 and 105 scans the Y electrodes to apply a voltage −Vsc alternately one-by-one to the Y electrodes and simultaneously scans the A electrodes to apply an address voltage Va to only those A electrodes connected to the selected display cells in each of which luminous discharge is to occur during the subsequent sustain period. In each of the selected display cells a voltage of (Vsc+Va) is applied between the Y electrode and the A electrode and discharge occurs. As a result luminous discharge occurs during the subsequent sustain period in the selected display cell. On the other hand 0V is applied to the A electrodes of the display cells, which are not selected and in each of which luminous discharge does not occur during the subsequent sustain period. No discharge occurs between the Y electrode and the A electrode in a display cell with only the voltage −Vsc applied to the Y electrode and this display cell is not selected.

During the sustain period the sustain voltages +Vs/2, −Vs/2 are alternately applied to each of the X electrode and the Y electrode in the selected display cell so that the positive sustain voltage is applied to one of the X electrode and the Y electrode with the negative sustain voltage applied to the other. As a result, luminous discharge is sustained in the selected display cell during this period. Since there is always a plus-and-minus difference in the sustain voltage applied between the X electrode and the Y electrode, which translates into each of the voltages +Vs, −Vs being alternately applied between the X electrode and the Y electrode, luminous discharge is sustained in the selected display cell during the sustain period.

The sustain voltage Vs needed to sustain luminous discharge in the conventional AC PDP device during the sustain period is approximately as high as 200 V, while the address voltage needed to select display cells for luminous discharge is approximately as high as 70 V.

Japanese Laid-open Patent Application No. 2009-157128 discloses a driving method for the above mentioned conventional AC PDP device to decrease the cost for used parts and production and power consumption as well, which is shown in FIG. 12.

According to the driving method disclosed in Japanese Laid-open Patent Application No. 2009-157128, a sustain driving circuit 104 for the X electrode is skipped and the X electrode is electrically connected with the metal chassis 101 of an AC PDP Device and grounded. Cost reduction due to skipping the X electrode and lower power consumption attributed to absence of loss in the sustain driving circuit 104 for the X electrode are realized at the same time.

This driving method is referred to as “One Side Driving Method” and reported in patent documents such as Japanese Patent Gazette No. 3666607, Japanese Laid-open Patent Application No. 2008-129552 and Japanese Laid-open Patent Application No. 2009-157128 and “New Two Stage Recovery (TSR) Driving Method Low Cost AC Plasma. Display Panel” published in pages 461 to 464 of The 12th International Display Workshops/Asia display 2005. Meanwhile the driving method shown in FIG. 10 and FIG. 11 is referred to as “Two Side Driving Method”.

FIG. 13 shows waveforms for One Side Driving Method described in Japanese Laid-open Patent Application No. 2009-157128. These waveforms are different from those used in Two Side Driving Method described in FIG. 11. There is a feature of this driving method that voltages Var, Vas both of which are approximately 200 V higher than Va (approximately 70 V) are applied by drivers 11, 13 in FIG. 12 to the A electrode during the reset and sustain period respectively.

Then an explanation is to be given on the voltage Vas applied to the A electrode during the sustain period.

In order to sustain luminous discharge over the sustain period, it is necessary to apply a difference voltage of ±Vs between the X electrode and the Y electrode. For this purpose the sustain square voltages +Vs/2, −Vs/2 (sustain pulses) are alternately applied to each of the X electrode and the Y electrode in the selected display cell so that the positive sustain voltage is applied to one of the X electrode and the Y electrode with the negative sustain voltage applied to the other.

On the other hand it is necessary to apply sustain voltages ±Vs (2Vsp−p) to the Y electrode during the sustain period in One Side Driving Method as indicated in FIG. 13 because the X electrode is grounded. If a constant voltage is applied to the A electrode during the sustain period, discharge is prone to occur between the Y electrode and the A electrode. Furthermore the fluorescent material layer is prone to deterioration caused by ion collisions because particle ions, which are generated by luminous discharge caused by the sustain pulse to apply ±Vs to the Y electrode, are drawn toward the A electrode. If the fluorescent material layer 7 deteriorates, this leads to a decrease in brightness.

If a pulse synchronized with the sustain pulse applied to the Y electrode during the sustain period is applied to the A electrode, it is possible to continue luminous discharge stably with no discharge occurring between the A electrode and the Y electrode. Furthermore the deterioration of the fluorescent material layer due to the ion collision is suppressed by the pulse applied to the A electrode.

FIG. 14 shows the inner condition in a display cell driven on Two Side Driving Method during the sustain period and FIG. 15 shows an inner condition in a display cell driven on One Side Driving Method during the sustain period. The inner condition in a display cell seen in FIG. 14 indicates luminous discharge being sustained.

On the other hand, if the voltage Vas, which is synchronized with the sustain pulse applied to the Y electrode 5y and is applied to the A electrode 5a, is too low, there occurs discharge between the Y electrode and the A electrode as seen in FIG. 15. If the voltage applied between the Y electrode and the A electrode in One Side Driving Method is made to be equal to that in Two Side Driving Method, it is necessary to apply a pulse whose amplitude is Vs to the A electrode. In order to apply Vs to the A electrode, the withstand voltage of the address driver 11c (in FIG. 12) has to be raised because the voltage Vs (approximately 200V) is higher than the voltage Va (approximately 70 V), as is already explained,

Besides, as is the case with the sustain period, the voltage Var is applied to the A electrode during the reset period in order to decrease the voltage difference between the Y electrode and the A electrode. During the reset period it is necessary to reset all the display cells with certainty by causing weak discharge to occur between the Y electrode and the A electrode. If the voltage difference is too large between the Y electrode and the A electrode, strong discharge (error discharge) occurs, which leads to a problem with an unstable reset operation.

As is clear from what is explained so far, it is necessary to apply voltages to the A electrode during both the reset period and the sustain period in One Side Driving Method in order to keep stable operation. To keep the voltage difference between the Y electrode and the A electrode equal to that on Two Side Driving method, the voltage Vs (approximately as high as 200 V) that is higher than the voltage Va (approximately 70 V) has to be applied to the A electrode.

FIG. 12 shows circuit components constituting an address driver shown in Japanese Laid-open Patent Application No. 2009-157128 and its peripheral components.

An output section of the address driver 11c comprises a switch element T1 to output a high level voltage, a switch element T2 to output a low level voltage, a level shift circuit to drive these switch elements, and by-pass diodes D1, D2. The collector terminal of the switch element T1 is connected with a power source for the voltage Va through a diode D5 and connected with another power source for Vac through a diode D6 which is inversely connected in-between. The address driver 11c further comprises a high voltage circuit (level shift circuit) M1 to convert low level signals output by a logic section to signals for driving the high voltage switch elements T1, T2. This level shift circuit occupies a large area in this driver IC.

According to One Side Driving Method described in Japanese Laid-open Patent Application No. 2009-157128, voltages Var, Vas, both of which are higher than the voltage Va, are applied to the switch elements T1, T2 and the level shift circuit to drive the switch elements T1, T2. As a result, a higher voltage is applied to the address driver circuit 105 in One Side Driving Method than in Two Side Driving Method shown in FIG. 10. Therefore there is a problem with the withstand voltage of the address driver for One Side Driving Method. That is, the withstand voltage of the address driver circuit for One Side Driving Method has to be higher than that for Two Side Driving Method. In order to raise the withstand voltage of the address driver 11, it is necessary to keep a larger region to secure electrical insulation and make a chip size of the address driver IC larger, which results in increase in the driver IC cost.

It is possible to significantly decrease a chip size of the address driver 11, if the level shift circuit M1 (Control Circuit) to control the elements T1, T2, which occupies a large area in an address driver 11 and whose withstand voltage is low, can be utilized in the address driver 11. The withstand voltage generally refers to a rated voltage of a semiconductor element and may be a yield voltage above which an avalanche break down current starts to flow through a reversely biased PN junction.

### SUMMARY OF THE INVENTION

The present invention is intended to solve problems related with conventional AC PDP Devices, and enables an AC PDP Device with a control circuit which controls the second switch element to apply a high level voltage to the third electrode and whose withstand voltage is lower than the conventional AC PDP Device has.

In order to solve problems with the conventional AC PDP Devices, the AC PDP Device of the present invention comprising, a plurality of first electrodes, a plurality of second electrodes (for instance, Y electrodes), the plurality of the first electrodes and the plurality of the second electrodes which are disposed substantially in parallel and alternate with each other, the adjacent first and second electrodes along which a display cell is formed and between which luminous discharge occurs in the display cell, a plurality of third electrodes which are formed across the display cells and substantially perpendicular to the first electrodes and the second electrodes, and are used to select the display cell in which the luminous discharge is to occur, and a first switch element (for instance, Q2) and a second switch element (for instance Q1), which keep the third electrode either at a low level voltage or a high level voltage, or in an open state, during an address period when the display cell in which the luminous discharge to occur is selected, wherein the first electrode is kept at a constant voltage while a positive voltage and a negative voltage with reference to the constant voltage are alternately applied to the second electrode with the first and the second switch elements both kept in the open state, during a sustain period when the luminous discharge is maintained, and wherein a withstand voltage of the second switch element to output the high level voltage is lower than a withstand voltage of the first switch element to output the low level voltage. This AC PDP Device preferably comprises a first diode (for example, Di) connected in series with the third electrode and a terminal which is of the second switch element and other than a positive terminal of the second switch element.

Each of a plurality of voltages applied to the second electrode is higher than the high level voltage applied to the A electrode. As a result, if a voltage left after the first positive voltage is divided in accordance with the ratio of the first wiring capacity to the second wiring capacity, which is higher than the high level voltage, is applied to the third electrode, a lower voltage is to be applied to the second switch element due to the first diode. As a result, there is no problem with lowering the withstand voltage of the control circuit to control the second switch element.

According to the present invention, the withstand voltage of the control circuit to control the second switch element through which the high level voltage is applied to the third electrode may be lowered. Due to the lowered withstand voltage of the control circuit, the withstand voltage of the second switch element is decreased and the chip size of an address driver is reduced, which leads to reduction of the production cost.

### BRIEF DESCRIPTION OF THE DRAWINGS

FIG. 1 is a block diagram to indicate components constituting the AC PDP Device for the first embodiment.

FIG. 2 is a circuit diagram of the address driver.

FIG. 3 is an explanation diagram for an electrode wiring example of a display panel of a conventional AC PDP Device.

FIG. 4 is a signal timing chart example of the controls signals used for an AC PDP Device driven on One Side Driving Method for the first embodiment of the present invention.

FIG. 5 shows a circuit diagram for an example of the address driver circuit used for the AC PDP Device for the second embodiment of the present invention.

FIG. 6 shows components constituting an AC PDP Device for the second embodiment of the present invention.

FIG. 7 shows a waveform applied to the A electrode used for the second embodiment of the present invention.

FIG. 8 is a perspective view of a display panel of a general AC PDP Device.

FIG. 9 shows a display cell disposed in a general AC PDP Device.

FIG. 10 is a block diagram for components constituting a conventional AC PDP Device.

FIG. 11 is a signal timing chart of the driving waveforms for a conventional AC PDP Device.

FIG. 12 shows circuit components constituting an address driver shown in Japanese Laid-open Patent Application No. 2009-157128 and its peripheral components.

FIG. 13 is a signal timing chart of waveforms for One Side Driving Method described in Japanese Laid-open Patent Application No. 2009-157128.

FIG. 14 shows the inner condition in a display cell of a general AC PDP device which is driven on Two Side Driving Method during the sustain period.

FIG. 15 shows an inner condition in a display cell of a conventional AC PDP device which is driven on One Side Driving Method during the sustain period.

### DETAILED DESCRIPTION OF THE INVENTION

### First Embodiment

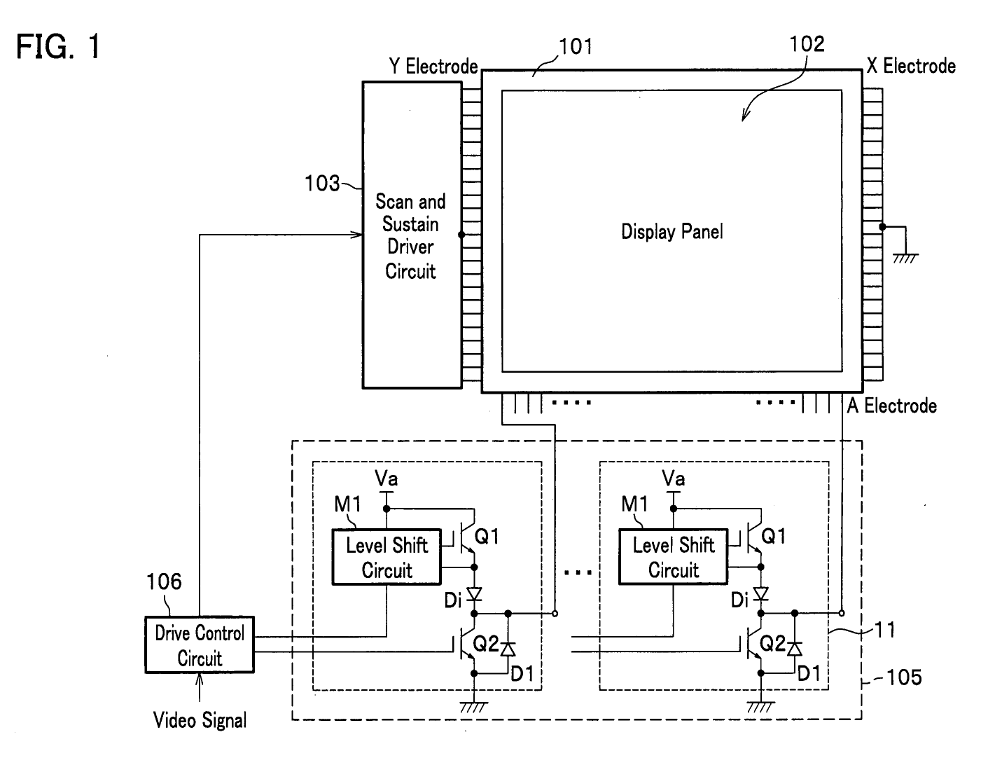

As is seen in FIG. 1, the AC PDP Device according to the first embodiment of the present invention comprises a display panel 102 supported by a metal chassis (housing) 101, a scan-sustain circuit 103 driving the Y electrodes in the display panel 102, an address driver circuit 105 and a drive control circuit 106 to which a video signal is inputted.

The X electrode is connected with the common electrode (GND) and kept at a predetermined fixed reference voltage, and may be connected with a metal chassis 101. The number of the address drivers 11 included in the address driver circuit 105 is equal to the number of the A electrodes.

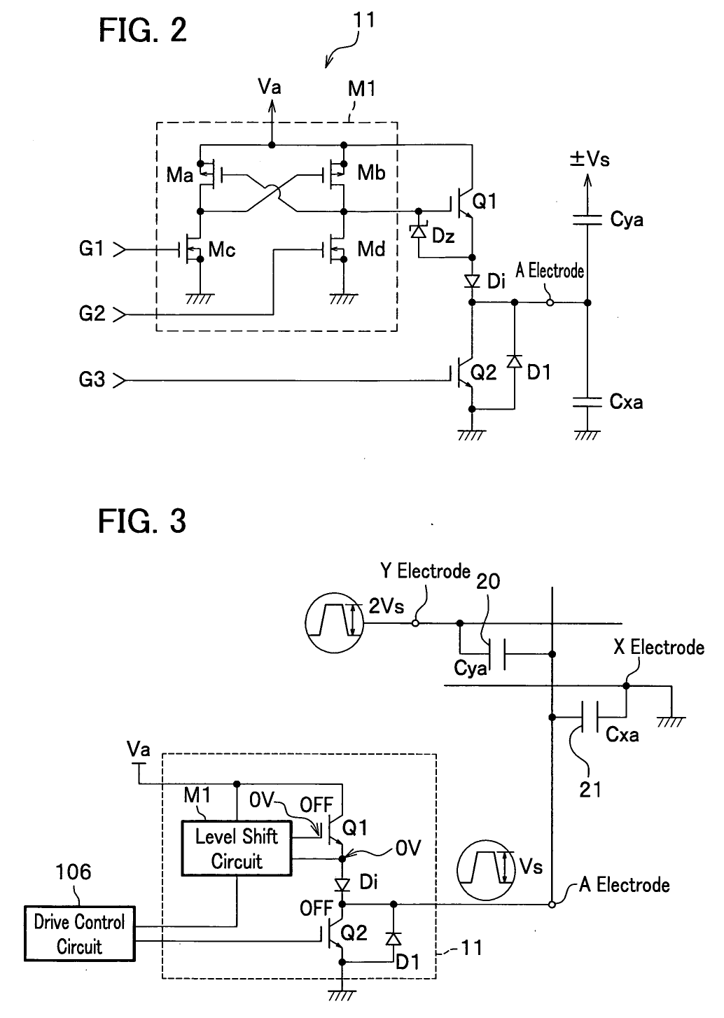

FIG. 2 is a circuit diagram of the address driver 11 and especially shows a concrete circuit of the level shift circuit. This address driver 11 has a feature that there is a separation diode Di connected between the emitter terminal of the switch element Q1 and a junction of an output terminal of the A electrode and the collector terminal of a switch element Q2, which is added to the circuit of the address driver 11a disclosed in Japanese Laid-open Patent Application No. 2009-157128.

More specifically, the address driver 11 includes switch elements Q1, Q2 for outputting signals, the separation diode Di, a by-pass diode D1, a zener diode Dz and a level shift circuit M1, and is driven by a voltage Va power source outputting a voltage of Va.

The voltage Va power source is connected with the level shift circuit M1 and the collector terminal of the switch element Q1. The emitter terminal of the switch element Q1 is connected with the anode of the separation diode Di. The cathode of the separation diode Di, the collector terminal of the switch element Q2, the A electrode and the cathode of the by-pass diode D1 are connected with one another. The emitter terminal of the switch element is connected with the anode of the by-pass diode D1. Moreover the gate terminal of the switch element Q1 is connected with the level shift circuit M1, and both the level shift circuit M1 and the gate terminal of the switch element Q2 are connected with a drive control circuit 106 and controlled by gate signals G1, G2, G3.

The level shift circuit M1 comprises a couple of switch elements Ma, Mb of p-MOS FET and a couple of switch elements Mc, Md of n-MOS FET. The drain terminals of the switch elements Ma, Mb are connected with the voltage Va power source. The source terminal of the switch element Ma is connected with the source terminal of the switch element Mc and the gate terminal of the switch element Mb while the source terminal of the switch element Mb is connected with the drain terminal of the switch element Md and the gate terminal of the switch element Ma. Both the source terminals of the switch elements Mc, Md are grounded.

Furthermore the gate terminal of the switch element Q1 is connected with the junction between the source terminal of the switch element Mb and the drain terminal of the switch element Md, the collector terminal of the switch element is connected with the voltage Va power source and the emitter terminal of the switch element Q1 is connected with the anode of the separation diode Di. The collector terminal of the switch element Q2 is connected with the cathode of the separation diode D1 while the emitter terminal of the switch element Q2 is grounded. There is a zener diode Dz connected between the gate terminal of the switch element Q1 and the emitter terminal of the switch element Q1 while there is a by-pass diode connected between the collector terminal of the switch element Q2 and the emitter terminal of the switch element Q2. The gate signals G1, G2, G3 outputted from the drive control circuit 106 in FIG. 1 are inputted respectively to the gate terminals of the switch elements Mc, Md, Q1.

As is explained above, as many as at least six transistor elements constitute the address driver 11. Therefore lowering the withstand voltages of these transistor elements according to this embodiment contributes to a significant decrease in the occupied area of the address driver 11.

FIG. 3 shows a circuit diagram of an address driver 11 for an A electrode among a plurality of the address drivers 11 and an circuit diagram of an equivalent circuit to PDP.

The A electrode is coupled with the X electrode through the wiring capacity Cxa 21, which stands for a wiring capacity between the X and A electrodes, and with the Y electrode through the wiring capacity Cya 20, which stands for a wiring capacity between the Y and A electrodes. The voltage pulse, which consists of a positive sustain voltage +Vs and a negative sustain voltage −Vs and whose voltage amplitude is 2Vsp−p, is applied to the Y electrode, while the X electrode is grounded.

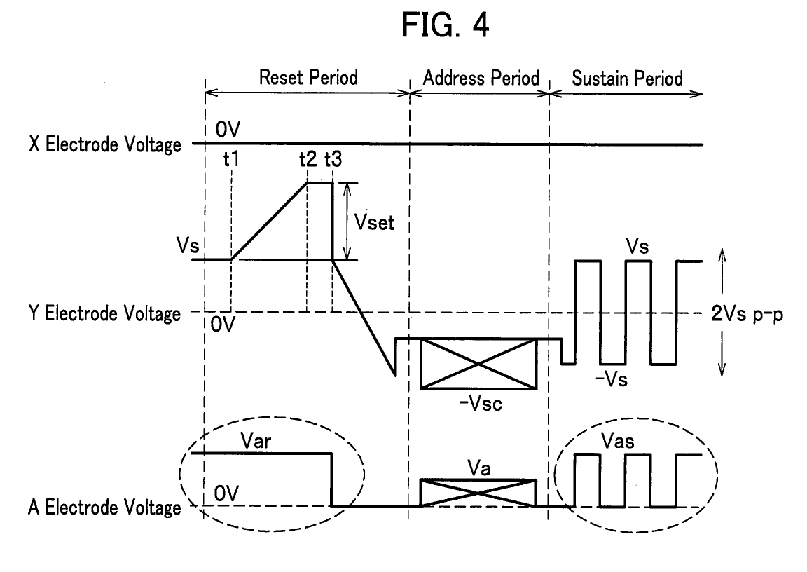

FIG. 4 shows driving wave forms for the AC PDP Device of this embodiment. As is seen in FIG. 4, the X electrode is kept at 0 V during the whole duration consisting of a reset period, an address period and a sustain period

During the reset period, the scan-sustain driver circuit 103 applies to the Y electrode a ramp function voltage which increases gradually from a voltage Vs at a time t1 to a voltage (Vs+Vset) at time t2 while the address driver circuit 105 applies to the A electrode a voltage Var higher than a voltage Va. As a result, a weak discharge occurs between the Y electrode and the X electrode and all the display cells are initialized.

The address period is a time to select the display cells in each of which luminous discharge is made to occur during the sustain period to come. During the address period, the address driver circuit 105 is scanning the A electrodes and applying a voltage Va to each of the A electrodes connected to the display cells to be selected, while the scan-sustain driver circuit 103 is scanning the Y electrodes one-by-one and apply a voltage −Vsc to each Y electrode. Accordingly the voltage of (Vsc+Va) is applied between the A electrode and the Y electrode in each of the display cells to be selected and discharge occurs during the address period in each of these selected display cells. As a result luminous discharge occurs during the subsequent sustain period in each of the selected display cells. If a display cell is not to be selected, the driver circuit 105 applies a voltage of 0 V to an A electrode connected to the display cell. In this case the voltage −Vsc is applied to this display cell and is not so large as to cause discharge to occur in the display cell. As a result this display cell is not selected.

The operation of the address driver is explained with reference to FIG. 2.

In order to output the voltage Va to the A electrode, a zener voltage on the zener diode Dz is applied between the gate terminal and the emitter terminal of the switch element Q1(IGBT) while both Mc(NMOS) and Mb(PMOS) are set to the on condition. Since the zener voltage is predetermined to be sufficiently higher than the threshold voltage of the switch element Q1, a collector current starts to flow and the voltage Va is outputted to the A electrode on the switch element Q1 becoming on.

On the other hand, 0V is applied to the A electrode by having the switch element Q1 off by applying 0V to both the gate terminal and the emitter terminal of the switch element Q1 while Md(NMOS) is set to the on condition.

During the sustain period a voltage Vas which is higher than the voltage Va (See FIG. 4) outputted from the voltage Va power source is applied to the A electrode.

The switch elements Q1, Q2, which are disposed at the output section of the address driver 11, are set to the off condition and the output section of the address driver 11 is set to a high impedance condition. The switch element Q2 can be set to the off condition by short-circuiting the gate terminal and the emitter terminal of the switch element Q2 in the drive control circuit. On the other hand, the switch element Q1 can be set to the off condition by grounding both the gate terminal and the emitter terminal of the switch element Q1 in the level shift circuit M1.

During the subsequent sustain period, positive and negative voltages ±Vs (“Vsp−p”) are alternately applied to the Y electrode. As a result, a voltage, which is left after the voltage applied to the Y electrode is divided according the ratio between wiring capacities Cya, CXa, is applied to the A electrode. Since the X electrode and the Y electrode are symmetrical with each other in the AC PDP Device panel, the wiring capacities Cya, Cxa are approximately identical with each other. Accordingly the voltage amplitude applied to the A electrode is approximately Vs, which is half as large as the voltage amplitude applied to the Y electrode.

If the voltage applied to the A electrode, which is kept in the high impedance condition, lowers as the voltage applied to the Y electrode, the voltage applied to the A electrode is between 0V and the voltage Vs because the voltage applied to the A electrode is clamped by the by-pass diode D1.

During the reset period that follows the sustain period, a higher voltage than the voltage Va can be applied to the A electrode by keeping both the switch elements Q1, Q2 off.

Looking to the operations of the AC PDP Device of this embodiment during both the sustain period and the reset period, the voltage applied to the A electrode, which is respectively a voltage between 0V and the voltage Vas and the voltage Var, is isolated by the separation diode Di. Therefore the voltages applied to the level shift circuit and the switch element Q1 are no higher than Va, which enables their withstand voltage to be lowered without causing any problem. The lowered withstand voltage contributes much to making the size of an address driver IC smaller although an address driver IC includes additionally separation diodes, because a diode which is relatively small does not occupy a large area in general.

Furthermore, integration of address drivers 11 into an address driver IC has a bigger effect on reducing the driver IC cost.

### Second Embodiment

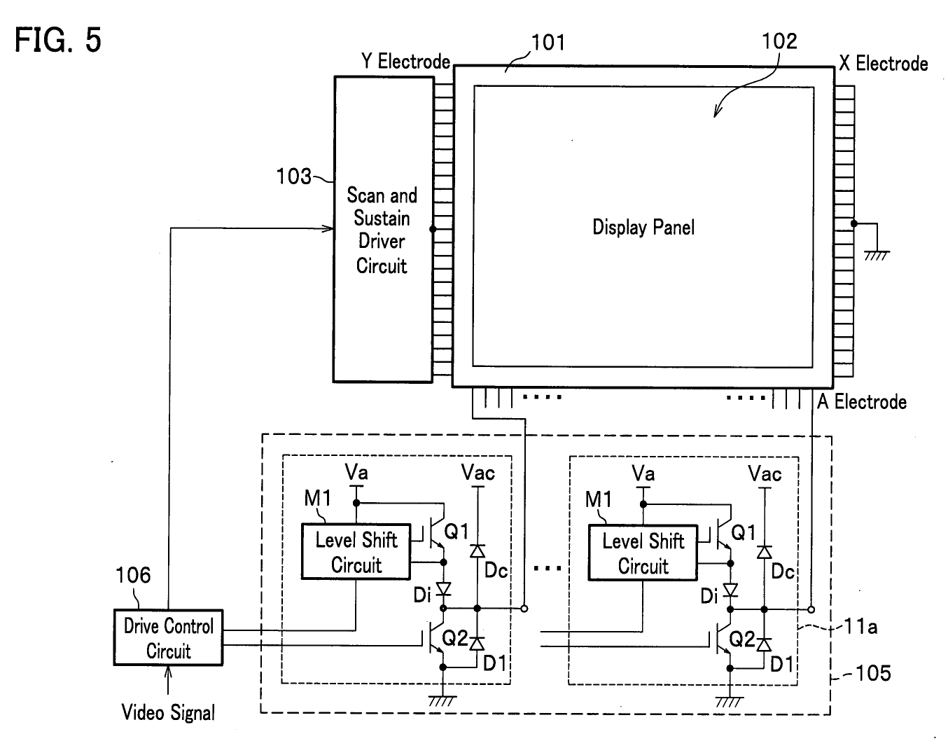

FIG. 5 shows a circuit diagram of the address driver circuit used for the AC PDP Device for the second embodiment of the present invention. A diode Dc and a voltage Vac power source is added to an address driver 11 in this embodiment. More specifically the anode of the diode Dc is connected with the junction between the cathode of the separation Di and the collector terminal of the switch element Q2 while the cathode is connected with the voltage Vac power source.

Making use of this address driver circuit, the voltage of the A electrode can be clamped and kept from exceeding the voltage Vac when the A electrode voltage varies as the Y electrode voltage varies. As a result, when a surge voltage is generated due to LC resonance resulting from a wire inductance and a display panel capacitance, an over voltage is prevented from being applied to the switch element Q2. Accordingly this address driver circuit enables lowering the withstand voltage of the switch element Q2.

### Third Embodiment

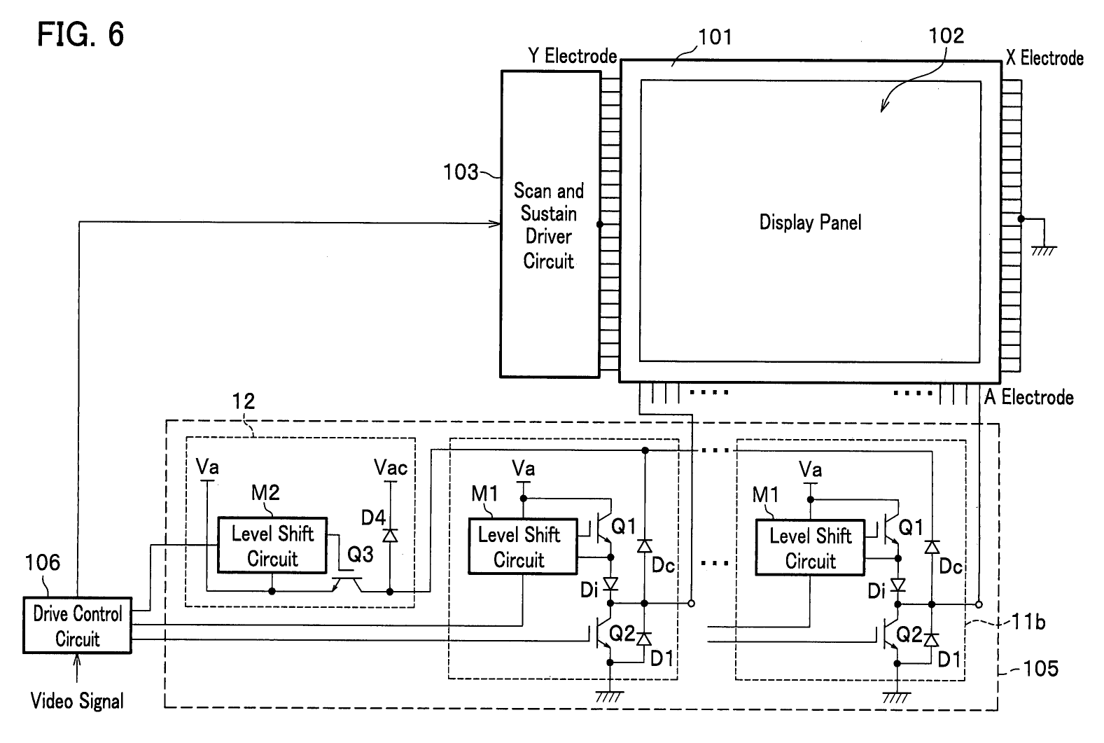

FIG. 6 shows components constituting a AC PDP Device for the third embodiment of the present invention.

The address driver circuit 105 used for the third embodiment has a feature that a switch element Q3 and a level shift circuit M2 to drive the switch element Q3 are added to the address driver circuit according to the second embodiment.

More specifically the address driver 105 utilizes the voltage Va power source and the switch element Q3, and the cathode of the diode Dc is connected with a junction between the collector terminal of the switch element Q3 and the anode of the diode D4, instead of the voltage Vac power source. In the address driver circuit 105, the emitter terminal of the switch element Q3 is connected with the voltage Va power source and the level shift circuit M2 while the gate terminal of the switch element Q3 is connected with the level shift circuit M2.

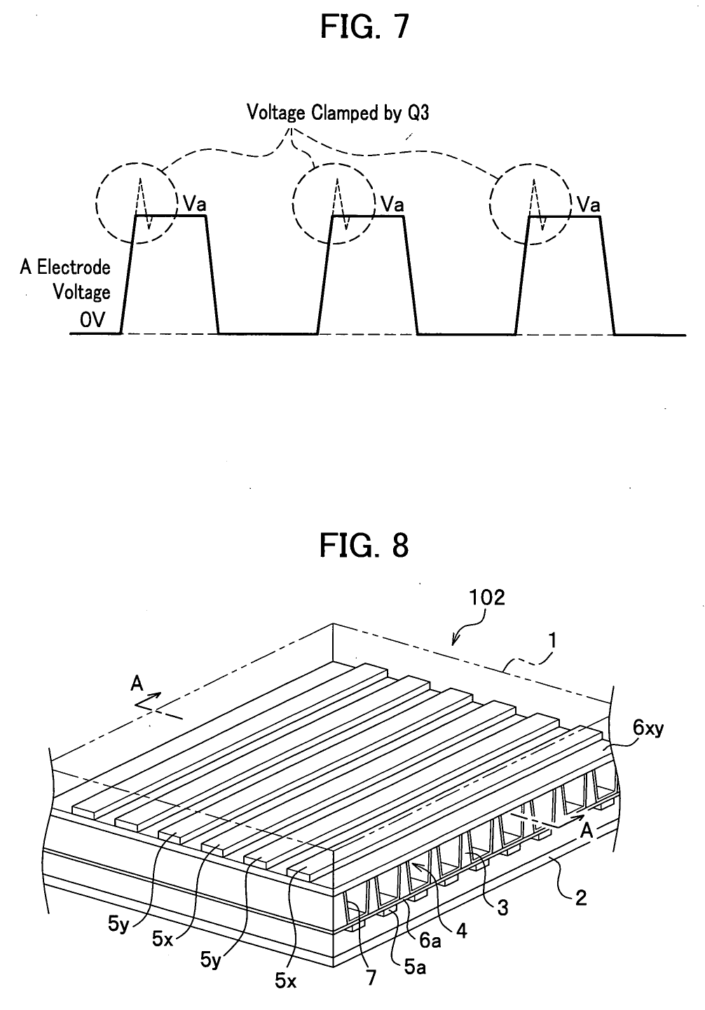

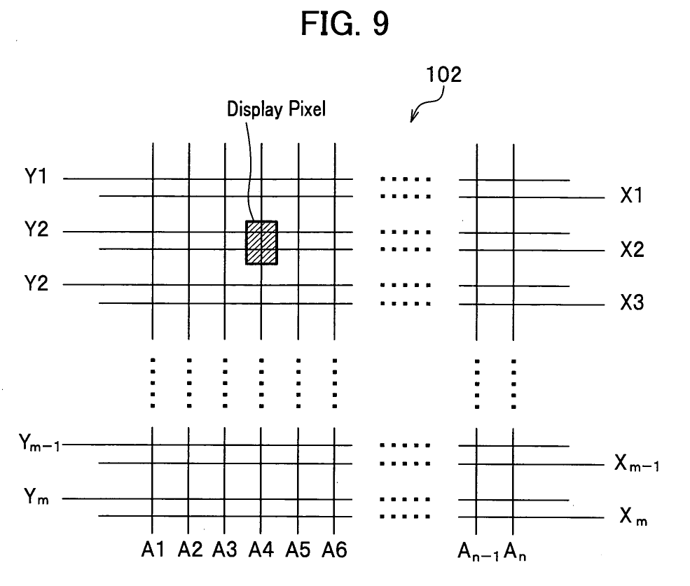

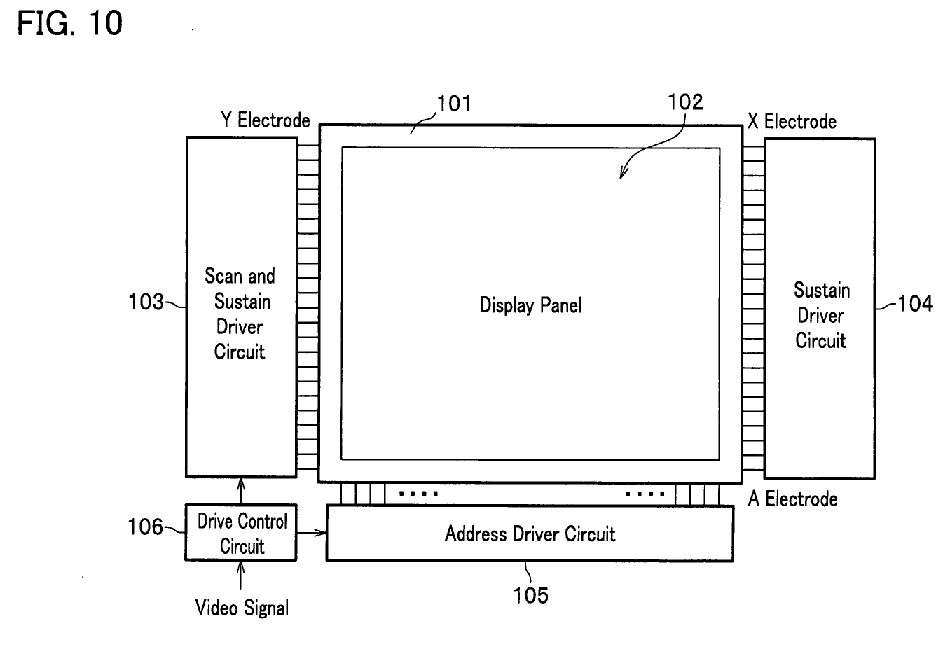

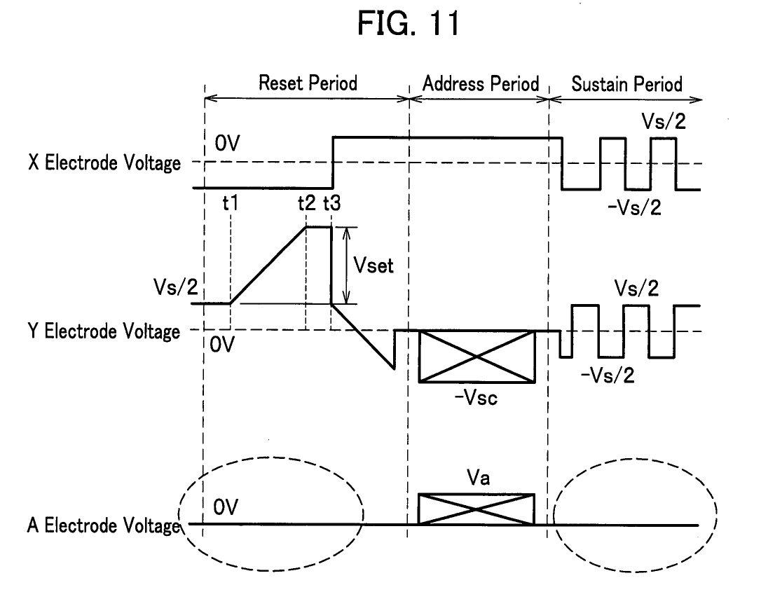

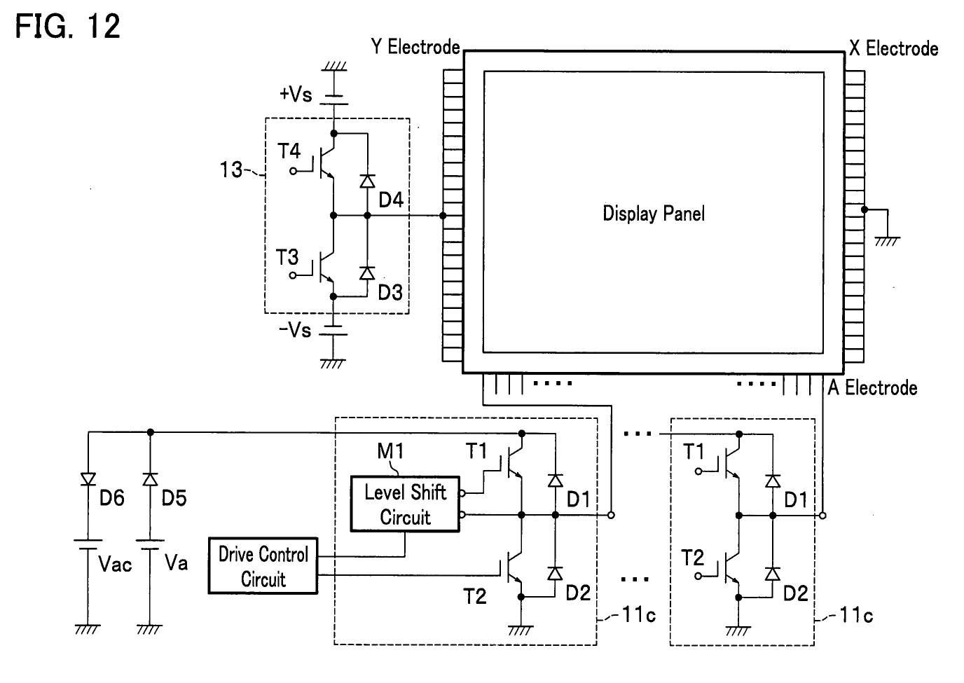

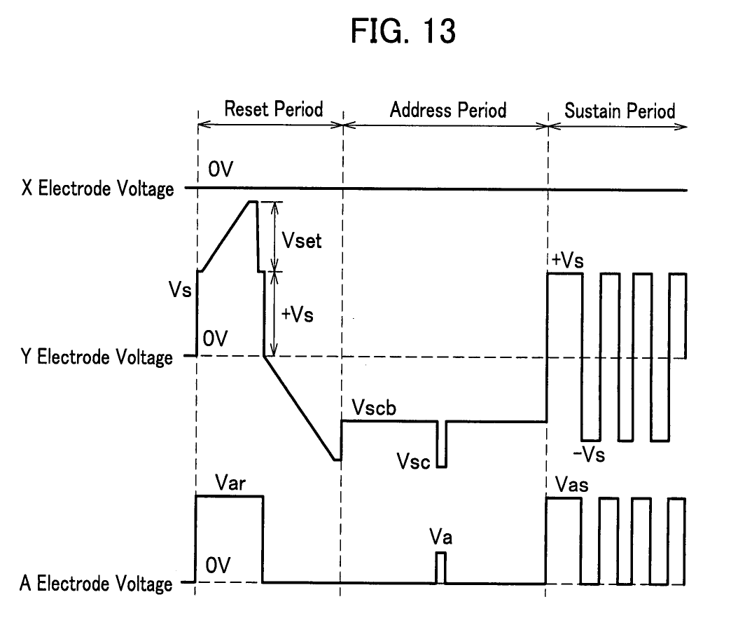

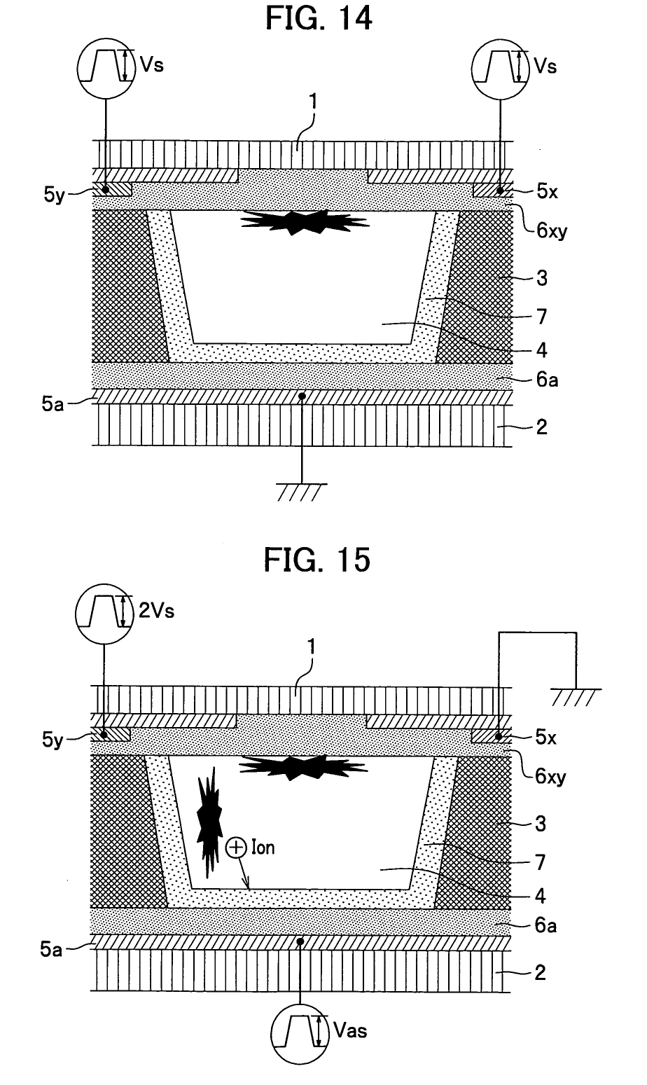

When the voltage Va is applied to the A electrode output terminal during the address period, a surge voltage as indicated by dotted lines in FIG. 7 is generated due to LC resonance between the wiring inductance and the display panel capacitance. Therefore it is possible that a display cell which is not to be selected is erroneously selected because a voltage higher than the voltage Va is applied to the A electrode. However this problem is efficiently prevented because the A electrode voltage is kept from exceeding the voltage Va by keeping the switch element Q3 on.

Furthermore the inventors have found and disclosed in Japanese Laid-open Patent Application No. 2009-157128 that IGBT (Insulated Gate Bipolar Transistor) has a higher driving capability for a unit element area than MOSFET due to IGBT's power output which is higher than MOSFET. If IGBTs are applied to the switch elements Q1, Q2, Q3 in the address driver of the present invention, they contributes to reducing the chip size of the address driver IC.

In the third embodiment, integration of the switch element Q3 in the address driver IC enables further reducing the chip size.

### Modified Embodiments

The present invention is not limited to those embodiments above mentioned and has the following modified embodiments for instance.

(1) In each of the above mentioned embodiments, the voltages of ±Vs which are symmetrical with respect to 0 V are alternately applied to the Y electrode while the X electrode is grounded. However it is also possible to alternately apply to the Y electrode the symmetrical voltages with respect to a predetermined fixed voltage while the X electrode is kept at this predetermined fixed voltage. In this case a first voltage and a second voltage which are respectively positive and negative with respect to the X electrode voltage are alternately applied to the Y electrode and the summation of the first voltage and the second voltage is the voltage is 2Vs.
(2) In each of the above mentioned embodiments, the power source such as the voltage Va or the voltage Vs power source is assumed to be a primary battery or a stabilized battery. However a secondary battery or a super capacitor can be applied to any embodiment.

What is claimed:

1. A plasma display device comprising,
a plurality of first electrodes,
a plurality of second electrodes,
the plurality of the first electrodes and the plurality of the second electrodes which are disposed substantially in parallel and alternate with each other, the adjacent first and second electrodes along which a display cell is formed and between which luminous discharge occurs in the display cell,
a plurality of third electrodes which are formed across the display cells and substantially perpendicular to the first electrodes and the second electrodes, and are used to select the display cell in which the luminous discharge is to occur, and
a first switch element and a second switch element, which keep the third electrode either at a low level voltage or a high level voltage, or in an open state, during an address period when the display cell in which the luminous discharge to occur is selected,
wherein the first electrode is kept at a constant voltage while a positive voltage and a negative voltage with reference to the constant voltage are alternately applied to the second electrode with the first and the second switch elements both kept in the open state, during a sustain period when the luminous discharge is maintained, and
wherein a withstand voltage of the second switch element to output the high level voltage is lower than a withstand voltage of the first switch element to output the low level voltage.

2. The plasma display device as described in claim 1,
wherein the constant voltage is a ground voltage and a lower voltage is applied to the second switch element than is applied to the third electrode.

3. The plasma display device as described in claim 1, further comprising a first diode connected in series with the third electrode and a terminal which is of the second switch element and other than a positive terminal of the second switch element,
wherein the positive terminal connected with a power source outputting the high level voltage.

4. The plasma display device as described in claim 3, further comprising,
a metal chassis for supporting a display panel in which the first electrode, the second electrode and the third electrode are formed,
wherein the first electrode is connected with the metal chassis.

5. The plasma display device as described in claim 1,
wherein the first electrode is connected with a power source keeping outputting the constant voltage or a capacitor kept at the constant voltage.

6. The plasma display device as described in claim 3, further comprising a second diode connected between the power source and the third electrode.

7. The plasma display device as described in claim 6, further comprising a third switch element for supplying electricity to the power source outputting the first voltage through the second diode.

8. The plasma display device as described in claim 7, wherein at least one of the first switch element, the second switch element and the third switch element is an IGBT element.

9. The plasma display device as described in claim 1, having a first wiring capacity between the first electrode and the third electrode and a second wiring capacity between the second electrode and the third electrode,
wherein a voltage left after the first voltage is divided in accordance with a ratio of the first wiring capacity to the second wiring capacity is applied to the third electrode when both of first switch and the second switch, which control a voltage of the third electrode, are kept in the open state.

10. The plasma display device as described in claim 9,
wherein a voltage applied to the second electrode is higher than the high level voltage and the voltage left after the first voltage is divided is higher than the high level voltage.

11. A semiconductor device used for a plasma display device comprising
a plurality of first electrodes,
a plurality of second electrodes,
the plurality of the first electrodes and the plurality of the second electrodes which are disposed substantially in parallel and alternate with each other, the adjacent first and second electrodes along which a display cell is formed and between which luminous discharge occurs in the display cell, and
a plurality of third electrodes which are formed across the display cells and substantially perpendicular to the first electrodes and the second electrodes, and are used to select the display cell in which the luminous discharge is to occur
the semiconductor device comprising
a first switch element and a second switch element, which keep the third electrode either at a low level voltage or a high level voltage, or in an open state, during an address period when the display cell in which the luminous discharge is to occur is selected, the second switch element having a positive terminal connected with a power source outputting the high level voltage, and
a first diode connected in series with the other terminal of the second switch element and the third electrode,
wherein at least one of a plurality of the first elements or a plurality of the second elements is integrated.
